(19) United States
(12) Patent Application Publication
(10) Pub. No.: US 2017/0277215 A1
(43) Pub. Date: Sep. 28, 2017

(54) ELECTRONIC DEVICE, POWER SOURCE CIRCUIT, AND INTEGRATED CIRCUIT

(71) Applicant: FUJITSU LIMITED, Kawasaki-shi (JP)

(72) Inventors: HIDEKI TAKAUCHI, Kawasaki (JP); Toshihiko Mori, Isehara (JP)

(73) Assignee: FUJITSU LIMITED, Kawasaki-shi (JP)

(21) Appl. No.: 15/415,407

(22) Filed: Jan. 25, 2017

(30) Foreign Application Priority Data
Mar. 23, 2016 (JP) 2016-059006

(51) Int. Cl. G05F 3/20

(52) U.S. Cl. CPC G05F 3/20

(57) ABSTRACT

An electronic device includes: an integrated circuit including a first power source terminal to which a first voltage is supplied from a DC power source, a second power source terminal to which a second voltage is supplied from the DC power source, a third power source terminal coupled to the first power source terminal through an internal resistance, and a fourth power source terminal coupled to the second power source terminal; and a power source circuit including a first power source line that supplies the first voltage to the first power source terminal from the DC power source, a second power source line that supplies the second voltage to the second power source terminal from the DC power source, and a bypass capacitor coupled between the third power source terminal and the fourth power source terminal.

### CROSS-REFERENCE TO RELATED APPLICATION

This application is based upon and claims the benefit of priority of the prior Japanese Patent Application No. 2016-059006, filed on Mar. 23, 2016, the entire contents of which are incorporated herein by reference.

### FIELD

The embodiments discussed herein are related to an electronic device, a power source circuit, and an integrated circuit.

### BACKGROUND

Integrated circuits and discrete circuits other than the integrated circuits operate by being supplied with a direct current (DC) power from a power source circuit.

Related technologies are disclosed in, for example, Japanese Laid-Open Patent Publication Nos. 2006-032823, 10-294429, and 2001-083217.

An object of the present disclosure is to implement an electronic device including a power source circuit having low impedance to suppress an occurrence of a resonance without using a chip capacitor called as a controlled ESR capacitor, and an integrated circuit.

### SUMMARY

According to one aspect of the embodiments, an electronic device includes: an integrated circuit including a first power source terminal to which a first voltage is supplied from a DC power source, a second power source terminal to which a second voltage is supplied from the DC power source, a third power source terminal coupled to the first power source terminal through an internal resistance, and a fourth power source terminal coupled to the second power source terminal; and a power source circuit including a first power source line that supplies the first voltage to the first power source terminal from the DC power source, a second power source line that supplies the second voltage to the second power source terminal from the DC power source, and a bypass capacitor coupled between the third power source terminal and the fourth power source terminal.

The object and advantages of the disclosure will be realized and attained by means of the elements and combinations particularly pointed out in the claims. It is to be understood that both the foregoing general description and the following detailed description are exemplary and explanatory and are not restirctive of the disclosure, as claimed.

### BRIEF DESCRIPTION OF DRAWINGS

FIG. 1 illustrates an example of an electronic device including an LSI and a power source circuit;

FIG. 2 illustrates an example of a simulation result;

FIG. 3 illustrates an example of an electronic device;

FIG. 4 illustrates an example of a simulation result;

FIG. 5 illustrates an example of an electronic device;

FIG. 6 illustrates an example of a simulation result;

FIG. 7 illustrates an example of an electronic device;

FIG. 8 illustrates an example of an electronic device;

FIG. 9 illustrates an example of an internal resistance;

FIG. 10 illustrates an example of a simulation result; and

FIG. 11 illustrates an example of a frequency characteristic of impedance.

### DESCRIPTION OF EMBODIMENTS

For example, an electronic device includes a large scale integrated (LSI) circuit and a power source circuit.

The impedance of a power source network that supplies a DC power from the power source circuit to the LSI is desirable to be low. In order to lower the impedance of the power source network, a bypass capacitor (hereinafter, referred to as a pass-capacitor) is coupled to a portion of the power source network close to the LSI.

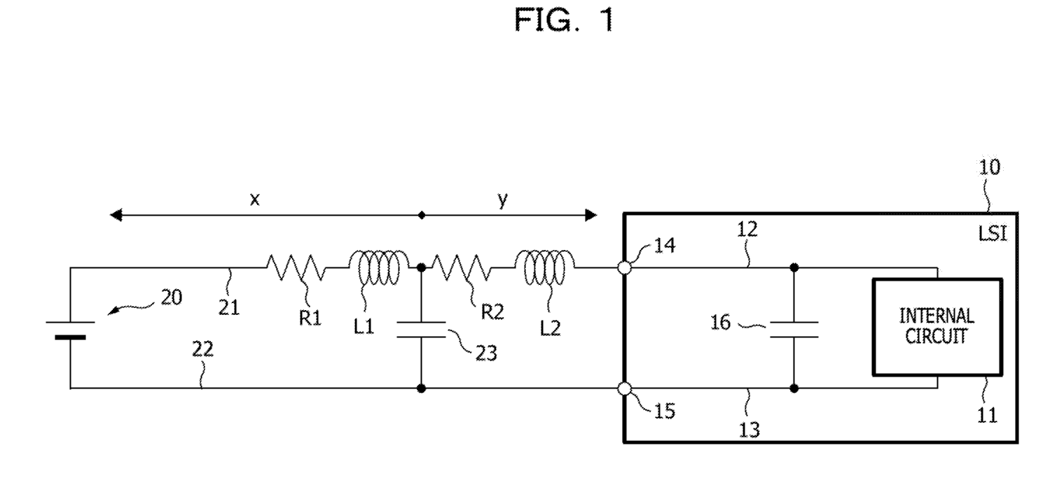

FIG. 1 illustrates an example of an electronic device. The electronic device includes an LSI, a power source circuit, and a power source network having a pass-capacitor. The LSI 10 includes an internal circuit 11, a high potential side power source line 12, a low potential side power source line 13, a first power source terminal 14, a second power source terminal 15, and an internal power source stability capacitor 16. The internal circuit 11 is a portion formed in an integrated circuit. The high potential side power source line 12 couples a high potential side power source terminal of the internal circuit 11 and the first power source terminal 14 to each other. The low potential side power source line 13 couples a low potential side power source terminal of the internal circuit 11 and the second power source terminal 15 to each other. The DC power supplied from the power source circuit to the first power source terminal 14 and the second power source terminal 15 is supplied to the internal circuit 11 through the high potential side power source line 12 and the low potential side power source line 13. The internal power source stability capacitor 16 is connected between the high potential side power source line 12 and the low potential side power source line 13, and stabilizes a voltage of the DC power applied to the internal circuit 11. For example, a plurality of internal power source stability capacitors 16 may be provided in a plurality of sites within the LSI 10, but herein, one representative internal power source stability capacitor 16 is represented. It may be difficult to increase a capacity value of the internal power source stability capacitor 16 due to the limitation to the size of the LSI 10.

The power source circuit supplies the DC power to the first power source terminal 14 and the second power source terminal 15. The power source circuit includes a DC power source 20 that generates the DC power, and a power source network. The power source network includes a first power source line 21 that couples between one terminal (e.g., a positive polarity terminal) of the DC power source 20 and the first power source terminal 14, and a second power source line 22 that couples between the other terminal (e.g., a negative polarity terminal) of the DC power source 20 and the second power source terminal 15. As illustrated in FIG. 1, a pass-capacitor 23 is coupled between nodes at which the first power source line 21 and the second power source line 22 are divided with a ratio of x:y.

The first power source line 21 and the second power source line 22 are wires each formed with a narrow line-width on a print board and generate a resistance and an inductance in proportion to a length. The resistance and the inductance between the node at which the first power source line 21 is divided with the ratio of x:y and the DC power source 20 are represented as R1 and L1, respectively, and the resistance and the inductance between the same node and the first power source terminal 14 are represented as R2 and L2, respectively. The resistance values of the resistances R1 and R2 are represented as R1 and R2, and the inductance values of the inductances L1 and L2 are represented as L1 and L2. These are identically applied to the following descriptions as well. Accordingly, the entire resistance and the entire inductance of the first power source line 21 are R1+R2 and L1+L2. For example, R1+R2=100 mΩ, and L1+L2=50 nH may establish. The second power source line 22 may also have the same or similar resistance and inductance as the first power source line 21.

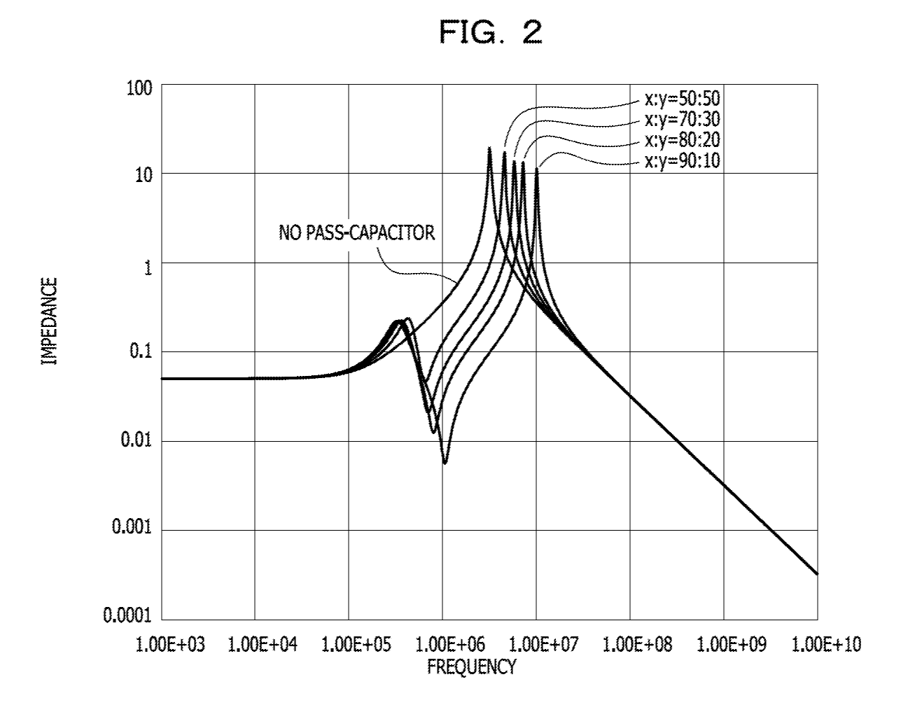

FIG. 2 illustrates an example of a simulation result. FIG. 2 represents a simulation result of an impedance variation of the power source circuit when the capacity of the internal power source stability capacitor 16 is 50 nF, the capacity of the pass-capacitor 23 is 5 μF, and x:y is 50:50, 70:30, 80:20, and 90:10, respectively. The ratio 90:10 represents a case where the pass-capacitor 23 is provided at the closest place to the LSI 10, and the ratio 50:50 represents a case where the pass-capacitor 23 is provided in the middle between the LSI 10 and the DC power source 20.

In FIG. 2, the horizontal axis represents a frequency, and the vertical axis represents an impedance. As illustrated in FIG. 2, when there is no pass-capacitor, the impedance is about 0.05 at a low frequency. The impedance increases with the increase of the frequency to exhibit a peak at around 3.0 MHz, and then decreases thereafter. When the pass-capacitor is provided, the impedance gradually increases to exhibit a first peak at around 300 kHz and decreases thereafter to exhibit a lower peak once at around 1 MHz. Then, the impedance increases to exhibit a second peak at around 4.0 MHz and decreases thereafter. As the ratio x:y is changed to 50:50, 70:30, 80:20, and 90:10, for example, as the position of the pass-capacitor becomes close to the LSI 10, the position of the peak moves to the high frequency side and a peak value (impedance) is gradually reduced. In FIG. 2, the arrow indicates a variation depending on the change of x:y. While the impedance decreases by the connection of the pass-capacitor as described above, for example, when the resistance value is sufficiently low, a resonance occurs by the capacity and the inductance, and the impedance increases at a certain frequency.

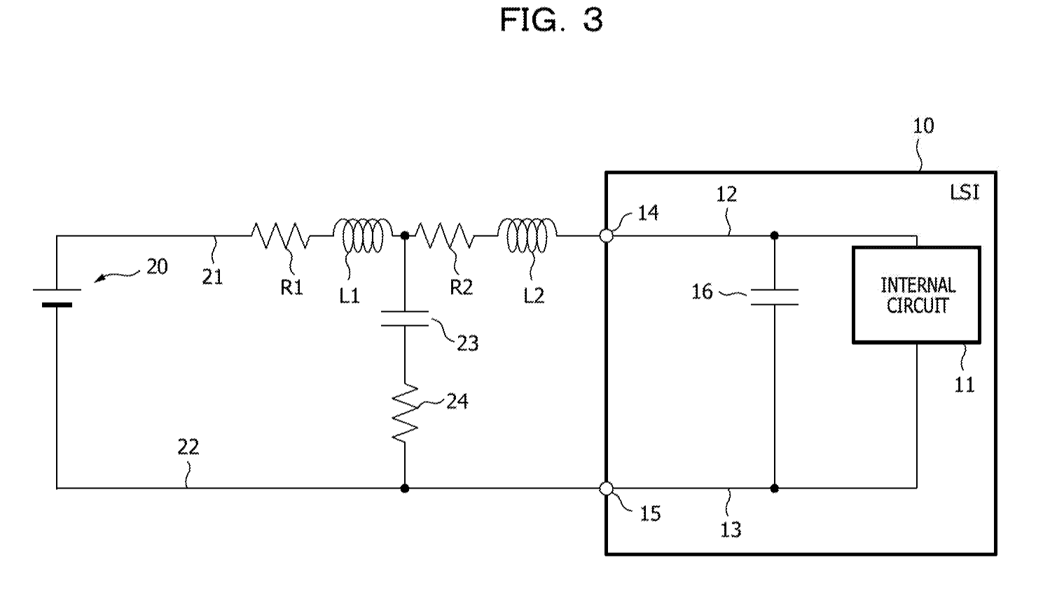

For example, a chip capacitor called a controlled ESR capacitor to which a resistance is coupled in series may be used as the pass-capacitor. FIG. 3 illustrates an example of an electronic device including an LSI and a power source circuit. The electronic device illustrated in FIG. 3 includes an LSI, a power source circuit, and a power source network having a pass-capacitor, and uses the chip capacitor as the pass-capacitor.

The configuration of FIG. 3 is different from that of FIG. 1 in that a series resistance 24 is coupled between the capacitor 23 and the second power source line 22. The capacitor 23 and the series resistance 24 form the chip capacitor. FIG. 3 illustrates a case where x:y=90:10, R1=90 mΩ, L1=45 nH, R2=10 mΩ, and L2=5 nH in FIG. 1. In this case as well, the capacity of the internal power source stability capacitor 16 may be 50 nF. As for the chip capacitor, plural kinds of combinations between a capacity value of the capacitor 23 and a resistance value of the series resistance 24 are provided.

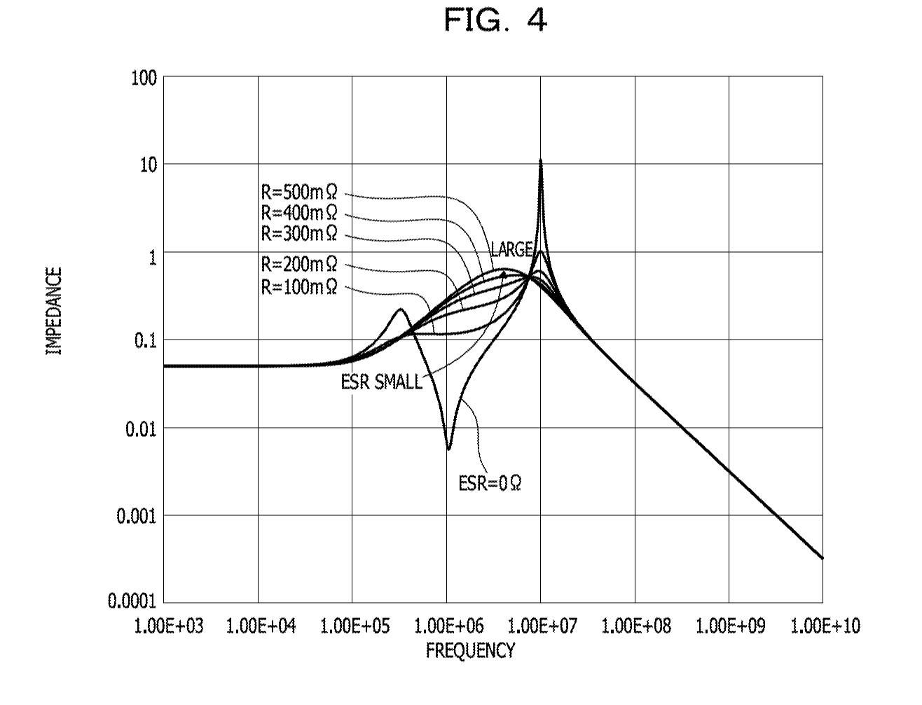

FIG. 4 illustrates an example of a simulation result. FIG. 4 represents a simulation result of a variation of the impedance of the power source circuit in the configuration of FIG. 3 under the same condition as that in FIG. 2 when the resistance value ESR of the series resistance 24 is changed by 100 mΩ from 100 mΩ to 500 mΩ. The case of ESR=0Ω represents a case where no series resistance 24 exists.

When the chip capacitor called a controlled ESR capacitor is used as the pass-capacitor, for example, when the series resistance 24 is formed, the extent of a resonance (a peak of a resonance) is reduced. For example, an occurrence of a resonance is reduced by the increase of the resistance value.

For example, as illustrated in FIG. 4, when the resistance value of the series resistance 24 becomes high, no resonance occurs, but the impedance increases overall. As for the chip capacitor called a controlled ESR capacitor, plural kinds of combinations between the capacity value of the capacitor 23 and the resistance value of the series resistance 24 are provided. However, since the kinds of combinations are limited, a combination of favorable values may not be selected. The chip capacitor may include a parastic inductance.

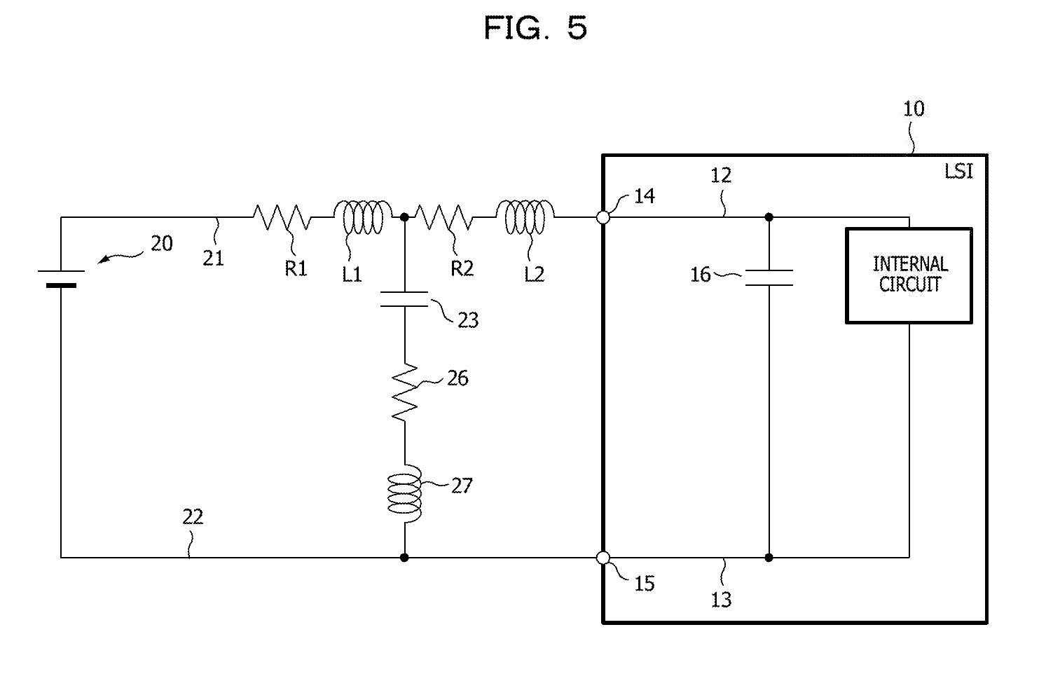

FIG. 5 illustrates an example of an electronic device. FIG. 5 represents a configuration of a case where the parastic inductance of the chip capacitor used as the pass-capacitor 23 is taken into account. FIG. 5 represents a case where x:y=90:10, R1=90 mΩ, L1=45 nH, R2=10 mΩ, and L2=5 nH in FIG. 1. It is assumed that the capacity value of the pass-capacitor 23 is 5 μF, and the resistance value of the resistance 26 is 300 mΩ. It is assumed that the capacity of the internal power source stability capacitor 16 is 50 nF.

For example, without using the chip capacitor, in the configuration of FIG. 1, the wire length between the pass-capacitor 23 and the second power source line 22 may be lengthened thereby forming the resistance 26 between the pass-capacitor 23 and the second power source line 22. In this case, when the wire is lengthened, an inductance 27 as well as the resistance occurs so that the configuration illustrated in FIG. 5 is provided.

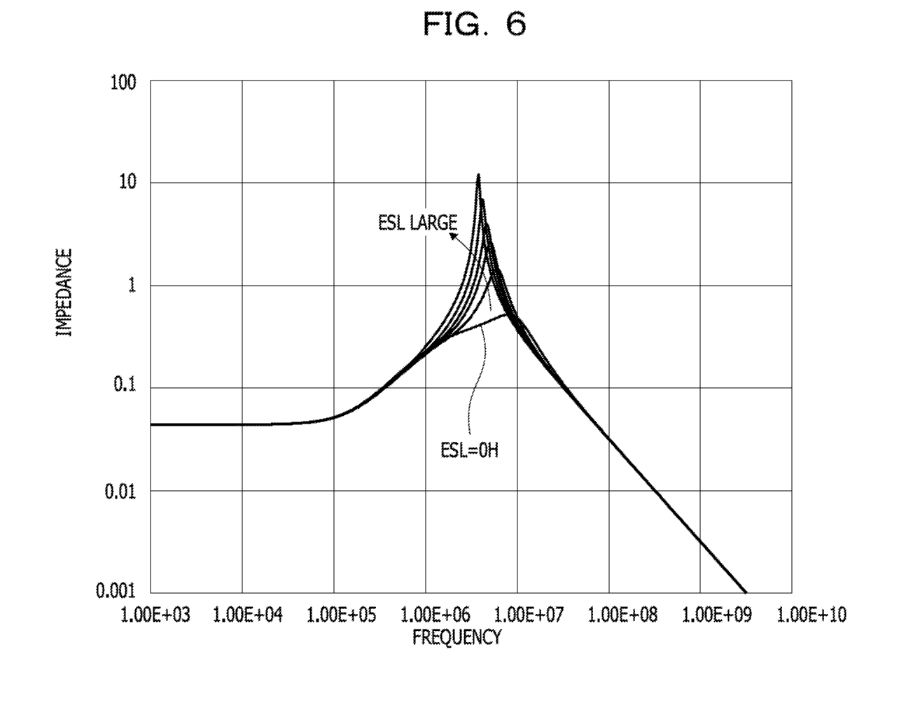

FIG. 6 illustrates an example of a simulation result. FIG. 6 represents a simulation result of a variation of the impedance, in the configuration of FIG. 5, when an inductance value ESL of the inductance 27 is changed to 10 nH, 20 nH, 30 nH, 50 nH, and 100 nH. ESL=0 H represents a case where no inductance 27 exists.

As illustrated in FIG. 6, a new resonance occurs when the inductance 27 is formed. Hence, as the inductance value of the inductance 27 increases, the peak of the resonance becomes high.

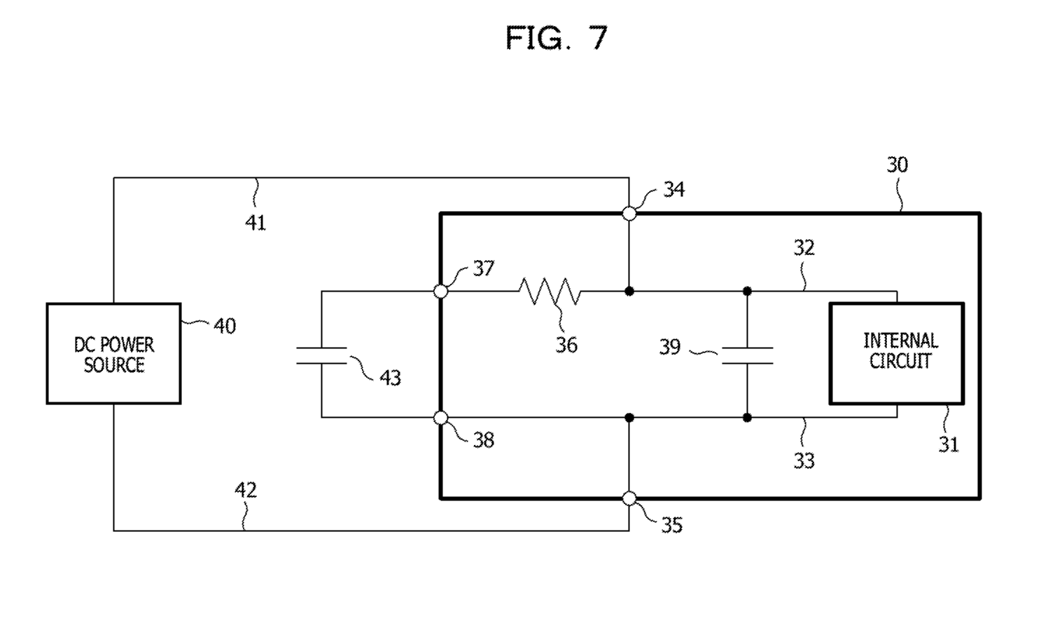

FIG. 7 illustrates an example of an electronic device. The electronic device illustrated in FIG. 7 includes an LSI 30 and a power source circuit.

The LSI 30 includes an internal circuit 31, a high potential side power source line 32, a low potential side power source line 33, a first power source terminal 34, a second power source terminal 35, an internal resistance 36, a third power source terminal 37, a fourth power source terminal 38, and an internal power source stability capacitor 39. The internal circuit 31 may correspond to a portion formed in an integrated circuit. The high potential side power source line 32 couples a high potential side power source terminal of the internal circuit 31 and the first power source terminal 34 to each other. The low potential side power source line 33 couples a low potential side power source terminal of the internal circuit 31, the second power source terminal 35, and the fourth power source terminal 38 to each other. The internal resistance 36 may be a resistance formed within the LSI 30 and having one terminal coupled between the high potential side power source line 32 and the third power source terminal 37. The third power source terminal 37 is coupled to the other terminal of the internal resistance 36. The fourth power source terminal 38 is coupled the low potential side power source line 33. The internal power source stability capacitor 39 is coupled between the high potential side power source line 32 and the low potential side power source line 33, and stabilizes the voltage of the DC power applied to the internal circuit 31. For example, a plurality of internal power source stability capacitors 39 may be provided within the LSI 30. However, FIG. 7 represents one representative internal power source stability capacitor 39. It may be difficult to increase the capacity value of the internal power source stability capacitor 39 due to the limitation in the size of the LSI 30. The LSI 30 includes the second power source terminal 35 and the fourth power source terminal 38 which are coupled to the low potential side power source line 33, but the second power source terminal 35 and the fourth power source terminal 38 may be unified.

The power source circuit includes a DC power source 40, a power source network, and a pass-capacitor 43. The power source network includes a first power source line 41 coupled between a positive side terminal of the DC power source 40 and the first power source terminal 34, and a second power source line 42 coupled between a negative side terminal of the DC power source 40 and the second power source terminal 35. The DC power source 40 supplies a DC power to the LSI 30 through the first power source line 41 and the second power source line 42. The pass-capacitor (bypass capacitor) 43 is coupled between the third power source terminal 37 and the fourth power source terminal 38 of the LSI 30. The pass-capacitor 43 is coupled close to the LSI 30, for example, with a short wire length, between the third power source terminal 37 and the fourth power source terminal 38. When the second power source terminal 35 and the fourth power source terminal 38 are unified, the pass-capacitor 43 is coupled close to the LSI 30 between the third power source terminal 37 and the second power source terminal 35.

As described above, the LSI 30 is different from the LSI 10 illustrated in FIGS. 1, 3, and 5 in that the LSI 30 includes the first power source terminal 34 and the third power source terminal 37 which are directly or indirectly coupled to the high potential side power source line 32. The pass-capacitor 43 in FIG. 7 is different from the power source circuit illustrated in FIGS. 1, 3, and 5 in that the pass-capacitor 43 of FIG. 7 is coupled between the third power source terminal 37 and the fourth power source terminal 38 of the LSI 30, rather than between the first power source terminal 34 and the second power source terminal 35. Since the impedance of the power source circuit is low, an occurrence of a resonance may be reduced.

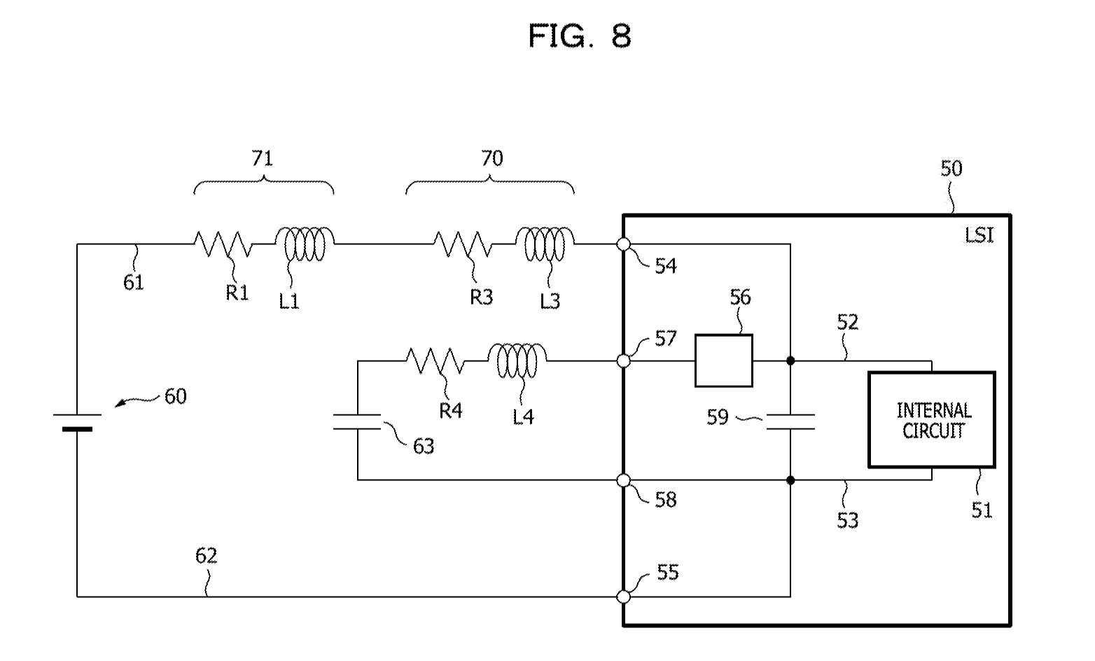

FIG. 8 illustrates an example of an electronic device.

The electronic device illustrated in FIG. 8 includes an LSI 50 and a power source circuit. The LSI 50 includes an internal circuit 51, a high potential side power source line 52, a low potential side power source line 53, a first power source terminal 54, a second power source terminal 55, an internal resistance 56, a third power source terminal 57, a fourth power source terminal 58, and an internal power source stability capacitor 59. The components other than the internal resistance 56 may be substantially the same as or similar to those illustrated in FIG. 7, and descriptions thereof may be omitted. The second power source terminal 55 and the fourth power source terminal 58 may be unified.

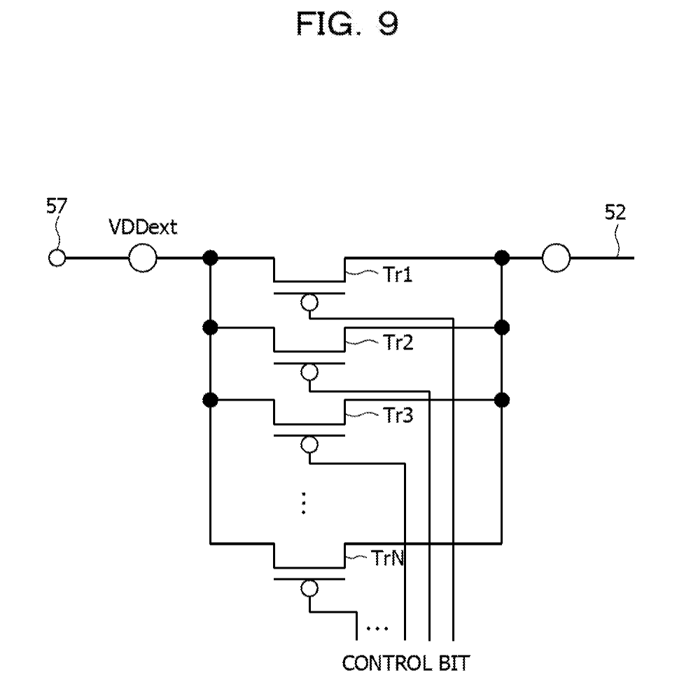

FIG. 9 illustrates an example of an internal resistance. The internal resistance illustrated in FIG. 9 may be the internal resistance 56 illustrated in FIG. 8. The internal resistance 56 includes N transistors (Tr1, Tr2, Tr3 , . . . , TrN) which are coupled in parallel with each other. The transistors (Tr1, Tr2, Tr3 , . . . , TrN) are turned ON when a control bit applied to a gate is high (1), and turned OFF when the control bit is low (0). The transistors (Tr1, Tr2, Tr3, . . . , TrN) exhibit an ON-resistance during ON, and the resistance is infinite during OFF. Accordingly, the resistance value is changed by controlling the number of transistors to be turned ON among the transistors (Tr1, Tr2, Tr3 , . . . , TrN) by the control bit. For example, the internal resistance 56 may function as a variable resistance. A transistor to be always turned ON without the application of the control bit may be provided, and the resistance value may be variable on the basis of the ON-resistance of the transistor. The resistance value of the internal resistance 56 may be variable around, for example, 400 mΩ.

The power source circuit illustrated in FIG. 8 includes a DC power source 60, a power source network, and a pass-capacitor 63. The power source network includes a first power source line 61 coupled between a positive side terminal of the DC power source 60 and the first power source terminal 54, and a second power source line 62 coupled between a negative side terminal of the DC power source 60 and the second power source terminal 55. The DC power source 60 supplies a DC power to the LSI 50 through the first power source line 61 and the second power source line 62. The pass-capacitor (bypass capacitor) 63 is coupled between the third power source terminal 57 and the fourth power source terminal 58 of the LSI 50.

The pass-capacitor (bypass capacitor) 63 is connected close to the LSI 50, for example, with a short wire length, between the third power source terminal 57 and the fourth power source terminal 58. For example, the first power source line 61 is divided into a portion 70 substantially the same as the wire length between the pass-capacitor 63 and the third power source terminal 57, and the other portion 71. For example, the wire portion between the pass-capacitor 63 and the third power source terminal 57, and the portion 70 of the first power supply line 61 may be wire portions formed on a surface layer of a print board on which the LSI 50 and the pass-capacity 63 are to be mounted. The portion 71 of the first power source line 61 may be a power source wiring layer inside the print board and is coupled to the surface layer of the print board through a via.

A summed line-width of the line-width of the wire portion between the pass-capacity 63 and the third power source terminal 57 and the line-width of the portion 70 of the first power source line 61 may be restricted by the relation of a wiring rule. For example, the resistance generated by the summed line-width may be R2, and a resistance value of the resistance R2 may be R2. The inductance generated by the summed line-width may be L2, and an inductance value of the inductance L2 may be L2. For example, the summed line-width may be divided into the line-width of the portion 70 of the first power source line 61 and the wire-width of the pass-capacity 63 at m:(1-m) (m is a value ranging from 1 to 0). A resistance value of the resistance R3 and an inductance value of the inductance L3 which are generated by the portion 70 of the first power source line 61 may be R3 and L3, respectively. A resistance value of the resistance R4 and an inductance value of the inductance L4 which are generated by the wire of the pass-capacitor 63 and the third power supply line 61 may be R4 and L4, respectively. In this case, R2=R3+R4, L2=L3+L4, and 1/R3:1/R4=1/L3:1/L4=m:(1-m). A resistance value of the resistance R1 and an inductance value of the inductance L1 which are generated by the portion 71 of the first power source line 61 may be R3 and L3, respectively.

As illustrated in FIG. 3, R1=90 mΩ, L1=45 nH, R2=10 mΩ, L2=5 nH, and a capacity value of the pass-capacity 63 may be 5 μF. An impedance variation of the power supply with respect to a frequency is obtained by a simulation in which a resistance value of the internal resistance 56 is set to 400 mΩ, a capacity value of the internal power source stability capacitor 59 is set to 50 nF, and the above-described m is changed from 1 to 0.1.

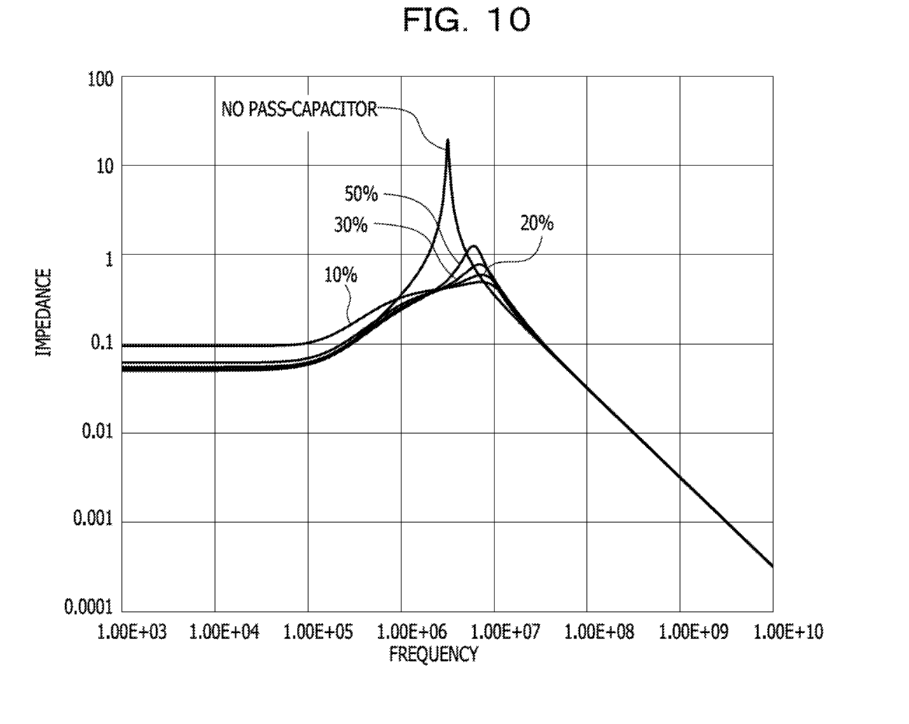

FIG. 10 illustrates an example of a simulation result. FIG. 10 represents the simulation result of the variation of the impedance of the power supply in the electronic device illustrated in FIG. 8. The m=1 represents a case where no pass-capacitor exists. As m is reduced and the proportion of the wire-width of the pass-capacitor 63 increases, the occurrence of a resonance is reduced while the resistance of the DC is hardly increased.

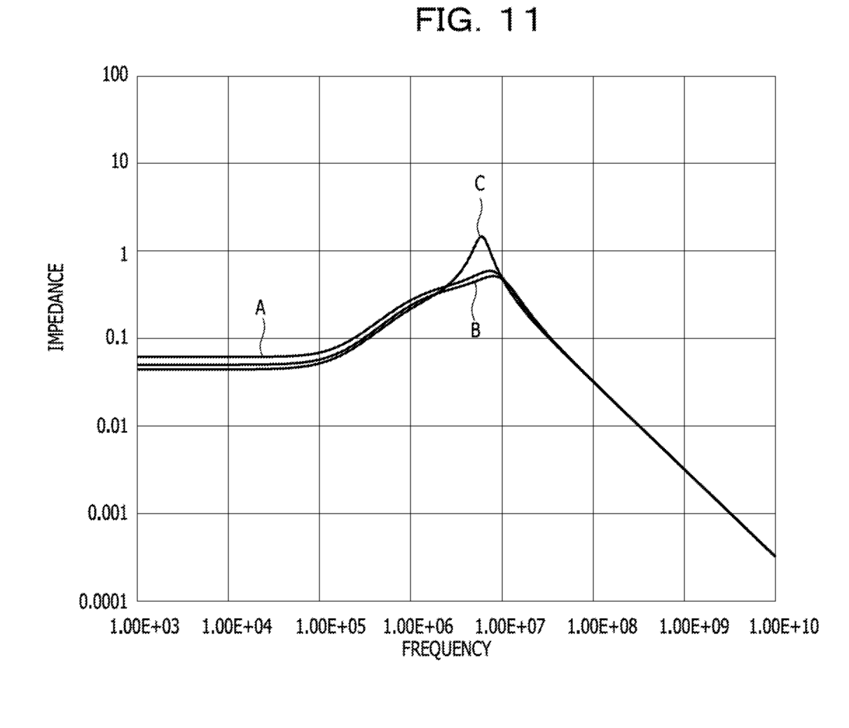

FIG. 11 illustrates an example of a frequency characteristic of impedance. FIG. 11 represents a frequency characteristic of the impedance through a simulation in a case illustrated in FIG. 8, a case in which an ideal ESR control chip capacitor is coupled in the configuration of FIG. 3 and a case in which the inductance is 10 nH in the configuration of FIG. 5.

In FIG. 11, the symbol “A” represents a characteristic of the case illustrated in FIG. 8. The symbol “B” represents a characteristic of the case where, in the configuration of FIG. 3, the ideal ESR control chip capacitor is coupled. The symbol “C” represents a characteristic of the case where, in the configuration of FIG. 5, the inductance is 10 nH. For example, the ideal ESR control chip capacitor may correspond to a case where, in the electronic device illustrated in FIG. 5 the inductance value of the inductance 27 is 0 nH and the resistance 26 of 300 mΩ is directly coupled to the capacitor 23 of 5 μF illustrated in FIG. 3.

As indicated by the symbol “B,” when the ideal ESR control chip capacitor is used, the occurrence of a resonance is reduced while the resistance of the DC is hardly increased. As indicated by the symbol “C,” a resonance occurs when the inductance of 10 nH is provided. As indicated by the symbol “A,” in the electronic device illustrated in FIG. 8, a slight increase of the impedance is exhibited, as compared to the case of symbol “B,” but the occurrence of a resonance is reduced.

In the electronic device illustrated in FIG. 8, the internal resistance 56 is a variable resistance. Hence, the resistance value of the internal resistance 56 is set after the LSI 50 is manufactured so that the characteristic indicated by the symbol “A” may be obtained.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. An electronic device comprising:
an integrated circuit including a first power source terminal to which a first voltage is supplied from a DC power source, a second power source terminal to which a second voltage is supplied from the DC power source, a third power source terminal coupled to the first power source terminal through an internal resistance, and a fourth power source terminal coupled to the second power source terminal; and
a power source circuit including a first power source line that supplies the first voltage to the first power source terminal from the DC power source, a second power source line that supplies the second voltage to the second power source terminal from the DC power source, and a bypass capacitor coupled between the third power source terminal and the fourth power source terminal.

2. The electronic device according to claim 1, wherein the second power source terminal and the fourth power source terminal are unified.

3. The electronic device according to claim 1, wherein the internal resistance is a variable resistance.

4. The electronic device according to claim 1, wherein the integrated circuit includes an internal capacity element coupled between the first power source terminal and the second power source terminal.

5. The electronic device according to claim 1, wherein the internal resistance includes a plurality of transistors coupled in parallel with each other between the first power source terminal and the third power source terminal, and a control signal is supplied to a gate terminal of each of the plurality of transistors.

6. A power source circuit comprising:
a DC power source;
a first power source line that supplies a first voltage of the DC power source from the DC power source to a first power source terminal of an integrated circuit;
a second power source line that supplies a second voltage of the DC power source from the DC power source to a second power source terminal of the integrated circuit; and
a bypass capacitor connected between a third power source terminal of the integrated circuit that is coupled to the first power source terminal through an internal resistance within the integrated circuit, and a fourth power source terminal of the integrated circuit that is coupled to the second power source terminal within the integrated circuit.

7. The power source circuit according to claim 6, wherein the second power source terminal and the fourth power source terminal are unified.

8. The power source circuit according to claim 6, wherein the internal resistance is a variable resistance.

9. The power source circuit according to claim 6, wherein the integrated circuit includes an internal capacity element coupled between the first power source terminal and the second power source terminal.

10. The power source circuit according to claim 6, wherein the internal resistance includes a plurality of transistors coupled in parallel with each other between the first power source terminal and the third power source terminal, and a control signal is supplied to a gate terminal of each of the plurality of transistors.

11. An integrated circuit comprising:
a first power source terminal to which a first voltage is supplied from a DC power source;
a second power source terminal to which a second voltage is supplied from the DC power source;
a third power source terminal connected to the first power source terminal through an internal resistance; and
a fourth power source terminal connected to the second power source terminal,
wherein the internal resistance coupled between the first power source terminal and the third power source terminal is a variable resistance.

12. The integrated circuit according to claim 11, wherein the second power source terminal and the fourth power source terminal are unified.

13. The integrated circuit according to claim 11, wherein the internal resistance is a variable resistance.

14. The electronic device according to claim 11, further comprising:
an internal capacity element coupled between the first power source terminal and the second power source terminal.

15. The electronic device according to claim 11, wherein the internal resistance includes a plurality of transistors coupled in parallel with each other between the first power source terminal and the third power source terminal, and a control signal is supplied to a gate terminal of each of the plurality of transistors.
